(19) United States
(12) Patent Application Publication
(10) Pub. No.: US 2011/0278754 A1
(43) Pub. Date: Nov. 17, 2011

(54) METHOD AND APPARATUS FOR CONTROLLING THE QUALITY IN THE MANUFACTURE OF COMPOSITE MATERIAL

(75) Inventors: Liisa Lehtinen, Lahti (FI); Risto Laaksonen, Lahti (FI); Piia Peltola, Hammeenlinna (FI)

(73) Assignee: UPM-KYMMENE CORPORATION, Helkinki (FI)

(21) Appl. No.: 13/147,045

(22) PCT Filed: Jan. 29, 2010
(86) PCT No.: PCT/FI2010/050053

§ 371 Date: Jul. 29, 2011

(30) Foreign Application Priority Data
Jan. 30, 2009 (FI) 20095082

(51) Int. Cl. B29C 31/10

(52) U.S. Cl. 264/40.7; 425/144

(57) ABSTRACT

The invention relates to a method and an apparatus for controlling the quality in the manufacture of composite material which contains fiber based and polymer based material, wherein the manufacture includes a mixing process (1) to form agglomerates from a raw stock mixture. According to the invention, a combination of variables in the mixing process is observed, wherein the variables are selected from the group of moment, current consumption, time, sound, temperature and their combinations, and the mixing process as well as the quality of the agglomerates to be formed is controlled based on the acquired observations (6, 7).

### FIELD OF THE INVENTION

The invention relates to a method as defined in the preamble of claim 1 and to an apparatus as defined in the preamble of claim 13 for controlling the quality in the manufacture of composite material.

### BACKGROUND OF THE INVENTION

Known from the prior art are different methods and apparatuses to feed solid raw stocks to a manufacturing process and/or to pretreat them before actual treatment. In processes where large masses of solid raw stock are used it has been problematic to observe the quality of the raw stock. In most analysis methods, the sample volume is so small that no reliable information of the actual quality of the raw stock can be acquired. In addition, observing the quality of intermediate products during their manufacturing has been problematic. It is known that information of the quality of an intermediate product is acquired only by determining the properties of the finished intermediate product.

There has been no industrial application for observing the quality of raw stock used in the manufacture of composite material and the quality of an intermediate product, such as agglomerate, formed in the pretreatment.

A problem with the use of solid raw stocks, particularly recycling based raw stocks, is their non-homogeneity and thus great variation in quality in connection with the manufacturing process of a composite product.

Known from reference WO 2007056839 is a process for manufacturing a composite from lignocellulosic fibers, polypropylene and maleated polypropylene. The manufacturing process includes mechanical premixing in which the raw stock composition is premixed for a certain time until a desired temperature is reached by means of shear forces of the mechanical mixing. The process or the properties of the product are not controlled based on observation of the temperature.

### OBJECTIVE OF THE INVENTION

The objective of the invention is to disclose a novel and reliable method and apparatus for monitoring and controlling quality in connection with the manufacture of composite material.

### SUMMARY OF THE INVENTION

The method and the apparatus according to the invention are characterized by what has been presented in the claims.

The invention is based on a method for controlling the quality and especially for monitoring the quality in the manufacture of composite material which contains fiber based and polymer based material, wherein the manufacture includes a mixing process, preferably as a pretreatment process, to form agglomerates from a raw stock mixture. According to the invention, a combination of variables in the mixing process is observed, wherein the variables are selected from the group of moment, current consumption, time, sound, temperature and their different combinations, and the mixing process as well as the quality of the agglomerates to be formed is controlled based on the acquired observations, e.g. measurements or observations by the operator, to provide agglomerates of good quality.

In one embodiment, the moment is measured, on the basis of which current consumption, preferably in amperes, is observed as a function of time. In one embodiment, temperature is measured, and temperature changes are observed as a function of time. In one embodiment, sound is observed based on auditory perception of the operator. In one embodiment, current consumption and temperature as a function of time as well as sound are observed. In one embodiment, current consumption is observed as a function of temperature.

In this context, by raw stock mixture is meant a mixture which may contain one or more raw stocks or one or more raw stock materials, e.g. recycling material. In addition, the raw stock mixture may contain additives, additional material and/or additional plastic. By raw stock is meant at least one raw stock or a mixture of a number of different raw stocks. The raw stock may be any raw stock or raw stock material which contains fiber based, e.g. wood fiber, straw, reed or flax based or other plant fiber based, and/or polymer based, such as plastic based, components. The wood fiber based material may be a paper based material. The fiber based material of the raw stock may contain ligneous material and/or ligninfree material, e.g. chemical pulp based paper or paper fiber or pure chemical pulp fiber.

In one embodiment, at least one raw stock is fed to the mixing process, preferably to pretreat the raw stock and to form agglomerates. In one embodiment of the invention, mainly solid raw stock is fed to the mixing process.

In one embodiment of the invention, additional material, additive and/or additional plastic is fed to the mixing process. The additional material, additive and/or additional plastic may be fed each as a separate or all as a combined feed to the mixing process or they may be combined with a specific raw stock feed before the mixing process.

Preferably, the manufacture of composite material includes a mixing process where the raw stock or raw stocks and optional additives, additional plastics and/or additional materials are mixed into a preferably homogenous raw stock mixture. In one embodiment, the mixing process includes a heating part. In one embodiment, the mixing process includes heating and cooling parts which are preferably located in the direction of motion of the raw stock flows so that the cooling part follows the heating part.

In one preferred mixing process, the material mixture is heated, normally to a temperature of approximately 200° C., whereby the plastic contained by the material mixture is fused at least partly so as to form agglomerates. After heating, the mixture is cooled, preferably to a temperature below approximately 70° C. The mixing process preferably includes heating and cooling parts as integrated in one device. In one embodiment, the mixing process is a hot-cold mixing process. In one embodiment, the heating part is heated by conducting warm air to the heating part.

In one embodiment of the invention, the variables of the mixing process are observed in the heating part of the mixing process.

In one embodiment of the invention, the method is used in monitoring the quality of the raw stock mixture.

In one embodiment, recycling material is fed to the mixing process as at least one raw stock. In one embodiment, adhesive laminate waste is fed to the mixing process as at least one raw stock. In one preferred embodiment, the raw stock to be fed to the mixing process consists mainly of adhesive laminate waste. In one embodiment, the raw stock contains at least one adhesive laminate waste component. In one embodiment, the raw stock contains more than one adhesive laminate waste component.

In one embodiment, the adhesive laminate waste contains adhesive material onto which a layer of glue has been provided, and fitted onto the layer of glue as a protective sheet is release material that can be easily released at the application site of the adhesive item. In one preferred embodiment, the adhesive material and/or release material contains a wood fiber based component and/or a plastic or polymer based or other organic component. Also, the use of different inorganic materials is possible. In one embodiment, the adhesive and/or release material is a wood fiber based paper, paperboard or the like. In one embodiment, the wood fiber based paper, paperboard or the like contains or is treated with plastic or polymer based material. In one embodiment, the adhesive and/or release material may be formed of substantially plastic or polymer based material. In one embodiment, the release material is formed mainly from plastic based material which contains e.g. polypropylene, polyethylene, polyethylene terephthalate or their mixtures. In one embodiment, the release material contains a silicone based component, such as siliconized material, e.g. siliconized film material. In one embodiment, the release material is coated with silicone based material or compound.

In one embodiment, finished adhesive laminate products, waste material produced from them and/or their manufacture may be used in the manufacture of composite material. In addition, waste material from the production and recycling material from the upgrading step or end use applications of adhesive laminate products may be used. In one embodiment, the adhesive laminate waste comes from adhesive laminate production which produces mainly production reject waste, edge trimming waste cut off from rolls and roll ends, from the adhesive laminate printing plant which produces mainly roll ends and adhesive material left over from die-cutting of stickers and labels as well as reject waste, and/or from the adhesive laminate end user customer who pastes the printed stickers and labels or the like on products. The waste from the end user is mainly release material, roll ends and waste from the finished product.

In one embodiment, the adhesive laminate waste may contain a variable number of different adhesive laminate waste components, such as adhesive material, glue and release material. The glue may be preferably provided in the adhesive material and/or release material.

In one embodiment, special recycling paper which is not accepted for the normal recycling paper and which may also contain glue, such as different catalogues, phone books or the like, may be used as at least one raw stock.

In one embodiment, the raw stock is preferably provided in a desired particle size, e.g. chopped into a desired particle size. In one embodiment, the particle size of the raw stock is preferably between 1 and 10 mm.

The method is used in monitoring and adjusting the quality of agglomerates formed in the mixing process. In a preferred embodiment, the objective is to provide in the mixing process agglomerates which are as homogeneous as possible. Another objective is to provide in the mixing process agglomerates which are as equal as possible in size, wherein the particle size is preferably between 1 and 20 mm. In this case, the agglomerate particles flow evenly, and no separation occurs e.g. during transportation. Quality of the agglomerates and the mixing process is controlled specifically during manufacture of the agglomerates. The primary objective of the invention is to form in one go agglomerates of good quality in an effective composition for a suitable further use. In this case, no unnecessary formation of the agglomerates occurs. Observation of the quality of agglomerates serves at the same time as quality control for the raw stocks to be fed. Factors contributing to the quality of the agglomerates, such as feeding and composition of the raw stock, additional material and/or additional plastic, can be observed already in the mixing process, through the process variables of the mixing process, whereby information about the direction in which the process must be adjusted to form agglomerates having the desired properties can be acquired sufficiently early.

It is problematic for the mixing process and further processes if the plastic is fused too early or too quickly in the mixing process or if the raw stock mixture contains undesirable ingredients. It can be noticed from current consumption of the mixing process when the plastic is fused too early or too quickly. In this case, it can be known that the raw stock mixture comprises undesirable ingredients.

In one embodiment, the problematic ingredient, i.e. the problematic plastic, of the raw stock mixture is polyethylene. Polyethylene may be mixed with the raw stock fed to the mixing process, e.g. adhesive laminate waste, or with the fed additional plastic, e.g. recycling plastic. Polyethylene is fused quickly at a relatively low temperature and has weak and undesirable quality properties considering the composite material to be formed. Polyethylene is fused at a lower temperature than e.g. PET or polypropylene.

In one embodiment, the problematic plastic is polypropylene which normally causes problems only in large quantities.

In addition, it is problematic for the mixing process of the composite material raw stocks if the raw stock mixture contains too large amounts of plastic fused at the process temperature. In this case, too large agglomerates are easily created in connection with the mixing. Too large agglomerates or their too large amounts are detected, preferably heard, as a raised sound, e.g. clatter, in the mixing process.

In addition, too quick temperature changes, e.g. temperature rise, indicate excessive amount of plastic that is fused at the process temperature and plastic that is fused too quickly at the process temperature, e.g. polyethylene, in the raw stock.

In one embodiment of the invention, the mixing process is controlled to provide agglomerate of good quality by adjusting the control parameters of the mixing process, such as feeding of raw stock, additional material, additional plastic and/or additive, or other suitable control parameter. In one embodiment, the mixing process is controlled by adjusting the amount of raw stock, additional material and/or additional plastic to be fed. In one embodiment, the mixing process is controlled by adjusting the feeding of raw stock. In one embodiment, the mixing process is controlled by selecting the raw stock to be fed.

In one embodiment of the invention, the mixing process is controlled by adjusting the feeding of additional material selected from the group of fibrous materials, organic fillers, inorganic fillers, powdery reinforcements, powdery additives, talc, wood fibers, chemical pulp fibers, paper and their combinations, to the mixing process. In one embodiment, feeding of additional material is increased. In an alternative embodiment, feeding of additional material is reduced.

In one embodiment of the invention, the mixing process is controlled by adjusting the feeding of additional plastic to the mixing process. In one embodiment, the amount of additional plastic to be fed is reduced. In an alternative embodiment, the amount of additional plastic to be fed is increased. Virgin and/or recycling plastic may be used as the additional plastic. The composite material may be manufactured with or without additional plastic. In one embodiment, adhesive laminate waste material, mixed with e.g. polyolefin, polypropylene, polyethylene (HDPE, LDPE) or other suitable plastic or their mixture as additional plastic, is used as raw stock to manufacture the wood composite material.

In one embodiment of the invention, the mixing process is controlled by stopping the feeding of at least one raw stock or the mixing process. If desired, the mixing process may be stopped if it is detected by observing the process variables that quality of the raw stock mixture or the agglomerates is not adequate. In one embodiment, the rejected raw stock may be conducted to another manufacturing process or returned to the manufacture of composite material e.g. as part of another raw stock.

In one embodiment, if the current consumption and/or temperature rise exceptionally fast, the mixing process is controlled by stopping at least one raw stock feed, stopping the mixing process, increasing the feeding of additional material and/or reducing the optional feeding of additional plastic, depending on the situation.

In one embodiment, if the sound heard from the mixing process becomes louder or the clatter is raised, the mixing process is controlled by stopping the feeding of at least one raw stock, stopping the mixing process, increasing the feeding of additional material and/or reducing the optional feeding of additional plastic, depending on the situation.

In one embodiment of the invention, the mixing process is controlled by adjusting the rotation speed of the mixer in the mixing process.

In one preferred embodiment, at least part of the additives, additional material and/or additional plastic used for the composite material is fed in a pretreatment process, such as a mixing process, to the raw stock mixture. In one embodiment, among the additives e.g. lubricant, fire retardant and adhesion promoter may be added to the mixing process.

In addition, the invention is based on an apparatus for controlling the quality in connection with the manufacture of composite material which contains fiber based and polymer based material. The apparatus includes a mixing device to form agglomerates from a raw stock mixture which consists preferably mainly of solid raw stock and solid additional material and/or additional plastic. In addition, the apparatus includes at least one feeding means to feed at least one raw stock to the mixing device. According to the invention, the apparatus includes at least one observation means to observe a combination of the mixing process variables, wherein the variables are selected from the group of moment, current consumption, time, sound, temperature and their different combinations, and a control unit to control the mixing process and quality of the agglomerates to be formed based on the acquired observations.

In one embodiment, the apparatus includes heating and cooling parts.

In one embodiment, the observation means is provided substantially in the heating part. In one embodiment, the observation means is a measuring sensor.

In one embodiment of the invention, the apparatus includes at least one feeding means to feed mainly solid raw stock to the mixing device.

In one embodiment of the invention, the apparatus includes at least one feeding means to feed additives, additional material and/or additional plastic to the mixing device.

In one embodiment, also manual control means such as different manually adjustable adjusting means may be used as the control unit.

In one embodiment of the invention, the control unit comprises reception means to receive signals from at least one observation means, calculation means to form control signals and give alerts, and control signal transmitting means to transmit the control signals formed in the calculation means.

In one embodiment of the invention, the control unit is arranged to adjust feeding of the raw stock, additional material, additional plastic and/or additives.

In one embodiment of the invention, the control unit is arranged to stop the mixing process. In one embodiment, the control unit is arranged to adjust the rotation speed of the mixer in the mixing device.

In one embodiment, the apparatus includes means for removing rejected raw stock from the process.

The method and the apparatus according to the invention provide considerable advantages as compared to the prior art.

Thanks to the invention, a means of quality control is provided for monitoring the quality of a raw stock mixture as well as the quality of the agglomerate formed in the process. Thanks to the invention, real information of the quality of raw stocks is acquired as compared with the analysis methods of the prior art. In addition, thanks to the invention, quality of the provided agglomerates can be observed in a reliable manner. In addition, the mixing process may be observed and adjusted or the mixing process may be stopped by the method according to the invention if the quality of the raw stock mixture and the agglomerate to be formed is not adequate.

By the invention, an industrially applicable, easy, quick and useful manner of monitoring and controlling quality during a mixing process is achieved.

### LIST OF FIGURES

FIG. 1 presents one apparatus according to the invention in a simplified schematic view, and

FIG. 2 presents current consumption of one application according to the invention as a function of temperature.

### DETAILED DESCRIPTION OF THE INVENTION

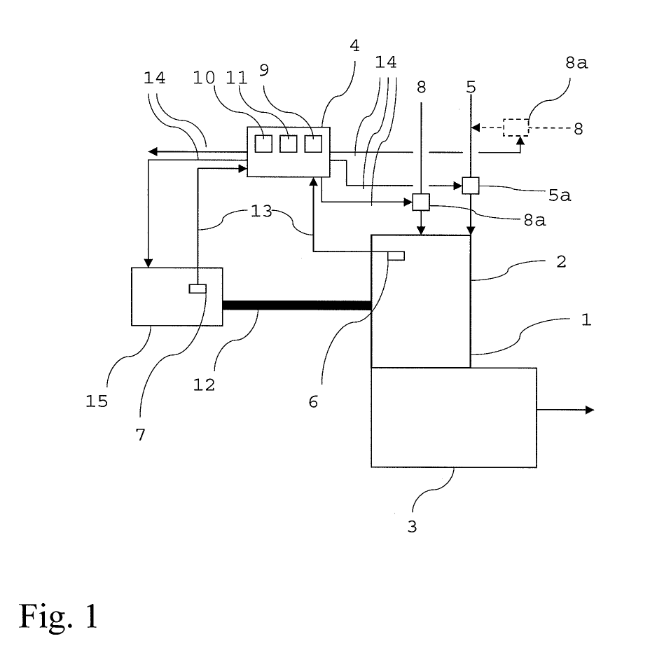

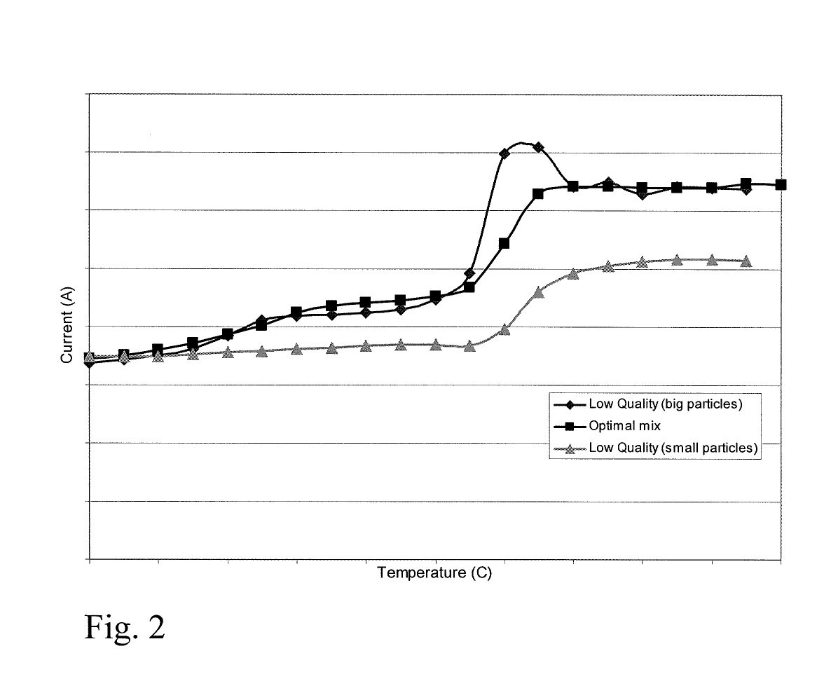

In the following section, the invention will be described in more detail with reference to the accompanying FIGS. 1 and 2.

FIG. 1 presents in a simplified schematic view one mixing device used in the manufacture of composite material. The mixing device is a so-called hot-cold mixing device (1) including heating (2) and cooling parts (3). Chopped adhesive laminate waste containing paper based material and plastic based material is fed as raw stock (5) to the heating part (2) of the mixing device through raw stock feeding means (5a) and is stirred by a mixer (12) provided in the heating part and equipped with a mixing engine (15). Installed in the heating part (2) of the mixing device is a temperature sensor (6), and installed in the mixing engine (15) is a sensor (7) that measures a variable associated with the moment and/or current consumption of the engine. The sound produced by the mixing device is observed by listening, and the time used for mixing may be measured. A mixer is also installed in the cooling part (3) of the mixing device but is not presented in the figure for the purpose of clarity.

Connected to the mixing device (1) is also a control unit (4) to monitor and control the quality. The control unit contains reception means (9) to receive signals (13) from the sensors, calculation means (11) to form control signals, and control signal trans-mitting means (10) to transmit the control signals (14) formed in the control unit. The calculation means (11) contain algorithms to process the signals from the sensors, to form control signals and to give alerts based on the provided control signals.

In addition, the mixing device includes means (8a) for feeding additional plastic, additional material and additives (8) to the mixing device with the raw stock (5). All these above-mentioned components are indicated in the figure by reference number 8. Additional plastic, additional material and additives (8) may also be fed to the raw stock (5) before the mixing device to form the raw stock mixture, this alternative being presented in the figure with a dashedline arrow.

The control unit (4) is arranged to adjust feeding of the raw stock (5) as well as additional material, additional plastic and additives (8) based on the variables and signals (13) from the sensors by transmitting control signals (14) to the raw stock feeding means (5a) as well as the additional material, additional plastic and additive feeding means (8a).

At least one variable of the mixing device, such as moment, current consumption, temperature of the heating part (2), time and sound is observed when the device is operational.

An apparatus according to the invention in which the variables to be observed include temperature and current consumption functions in the following way:

Sensors provided in the mixing device measure the process substantially continuously. The calculation unit of the control unit observes the moment, current consumption and/or temperature of the heating part as a function of time. In addition, the control unit observes the total processing time. Process variable curves at set values are stored in the calculation unit and are compared by the calculation unit with values acquired as a result of the measurements and/or calculation. For example, if the control unit detects that the temperature rise is very quick and that it diverges substantially from the normal temperature rise curve in this process step, the control unit transmits a process stop command and gives an alert. A reason for the diverging temperature curve is often that the raw stock mixture contains too much polyethylene which is fused too fast. As a result, the used raw stock mixture is rejected and conditioned further. Alternatively, the feed ratio of raw stock, additional material and/or additional plastic may be changed.

If the control unit of the mixing process detects that load on the mixer engine increases abruptly, the control unit gives the mixer engine a control command to lower the rotation speed.

One variable that can be observed is the sound heard from the mixing process. If it rises louder than usually or changes into clatter, the operator stops the mixing process. A reason for the clatter is often that too big agglomerates have been formed in the process in comparison with the target size. The target size of the agglomerate is preferably between 1 and 5 mm. Production of oversized agglomerates is most often due to the fact that the raw stock mixture contains too much plastic in relation to other infusible material. Plastic produces too big agglomerates as it is fused at the process temperature. A raw stock mixture that contains too big agglomerates may be either rejected or conditioned for example by adding talc to the raw stock mixture, in which case the proportion of plastic can be reduced. Instead of talc, e.g. other fibrous material may be used. Alternatively, the mixing process may also be adjusted by reducing the amount of optionally fed additional plastic, in which case the proportion of plastic can be reduced as well.

### Example 1

In this test, formation of the agglomerate by the mixing apparatus according to FIG. 1 and quality of the provided agglomerate were examined.

Quality of the agglomerate was controlled by observing the process variables and adjusting the control parameters of the mixing process, i.e. feeding of the raw stock, additional material and additional plastic as well as the rotation speed of the mixer, based on observations acquired from the process variables. The process variables to be observed included temperature and current consumption. If necessary, feeding of the raw stock, additional material and/or additional plastic could be interrupted.

FIG. 2 presents current consumption measured in the test as a function of temperature. The acquired process variable curve was compared with the known process variable curve to form agglomerate of good quality. Based on the comparison, the control parameters were adjusted to a right direction to provide agglomerate of good quality. This way, composition of the raw stock mixture and quality of the agglomerate being formed could be controlled.

FIG. 2 shows that when current consumption rises too high, the size of the agglomerate has grown too much, which causes choking of the pipeworks e.g. after the mixing device in further applications of the agglomerate. This led to the conclusion of the raw stock being mixed with too much plastic or with wrong type of plastic. To correct this, the amount of virgin additional plastic to be added could be reduced or the batch size could be diminished. If current consumption did not rise high enough, the agglomerate was too small in size, which hinders operation in further applications of the agglomerate. To correct, the amount of virgin additional plastic to be added could be raised or the batch size increased. In optimal mixing, the agglomerate is quite equal in size and moves easily in the mixing device. When the variable curve was close to the optimal curve, it was discovered that the material ratios were right. In this case, the raw stock mixture functioned well in the mixing process and the agglomerate product being prepared was of good quality.

In the tests it was discovered that the method and the apparatus according to the invention suit especially well for monitoring the quality of a raw stock mixture and agglomerates. The method is easy to use and results are acquired in real time.

The method and the apparatus according to the invention suit in different embodiments for use in quality control of most different raw stock mixtures and agglomerates in connection with the manufacture of composite materials.

The invention is not limited merely to the examples referred to above; instead, many variations are possible within the scope of the inventive idea defined by the claims.

1. A method for controlling the quality in the manufacture of composite material which contains fiber based and polymer based material, wherein the manufacture includes a mixing process to form agglomerates from a raw stock mixture, wherein a combination of variables in the mixing process is observed, wherein the variables are selected from the group of moment, current consumption, time, sound, temperature and their combinations, and the mixing process and quality of the agglomerates to be formed is controlled based on the acquired observations, and additional material, additive and/or additional plastic is fed to the mixing process and the mixing process is controlled by adjusting the feeding of raw stock, the feeding of additional material, the feeding of additive and/or the feeding of additional plastic.

2. The method according to claim 1, wherein the method is used in monitoring the quality of a raw stock mixture.

3. The method according to claim 1, wherein mainly solid raw stock is fed to the mixing process.

4. The method according to claim 1, wherein adhesive laminate waste is fed to the mixing process.

5. The method according to claim 1, wherein the mixing process is controlled by stopping the feeding of at least one raw stock.

6. The method according to claim 1, wherein the mixing process is controlled by stopping the mixing process.

7. The method according to claim 1, wherein the mixing process is controlled by adjusting the rotation speed of the mixer.

8. The method according to claim 1, wherein variables of the mixing process are observed in the heating part of the mixing process.

9. An apparatus for controlling the quality in connection with the manufacture of composite material which contains fiber based and polymer based material, wherein the apparatus includes a mixing device to form agglomerates from a raw stock mixture, and at least one feeding means to feed at least one raw stock to the mixing device, characterized in that the apparatus includes at least one feeding means to feed additives, additional material and/or additional plastic to the mixing device and at least one observation means to observe a combination of variables in the mixing process, wherein the variables are selected from the group of moment, current consumption, time, sound, temperature and their combinations, and a control unit to control the mixing process and quality of the agglomerates to be formed based on the acquired observations, and the control unit is arranged to adjust feeding of raw stock, additional material, additional plastic and/or additives.

10. The apparatus according to claim 9, wherein the apparatus includes at least one feeding means to feed mainly solid raw stock to the mixing device.

11. The apparatus according to claim 9, wherein the control unit comprises reception means to receive signals from at least one observation means, calculation means to form control signals and give alerts, and control signal transmitting means to transmit the control signals formed in the calculation means.

12. The apparatus according to claim 9, wherein the control unit is arranged to stop the mixing process.

13. The apparatus according to claim 9, wherein the control unit is arranged to adjust the rotation speed of the mixer in the mixing device.

14. The apparatus according to claim 9, wherein the observation means is a measuring sensor.
